(19) United States
(12) Patent Application Publication
(10) Pub. No.: US 2009/0193275 A1
(43) Pub. Date: Jul. 30, 2009

(54) Quick-Stop Feature For Multiple Output Power Systems

(75) Inventors: Richard A. Carlson, Newton, NJ (US); Cynthia L. Caffrey, Blairstown, NJ (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/023,023

(22) Filed: Jan. 30, 2008

(51) Int. Cl. G06F 1/32; G06F 1/26

(52) U.S. Cl. 713/323; 713/300

(57) ABSTRACT

A quick-stop feature built into power systems enables deactivating the power output of output supplies in the shortest possible time. This feature prevents damage to the power system and to the electrical devices connected to the output supplies. The quick-stop feature can be implemented as a hardware or a software solution. A button on the front panel of the power system can initiate the quick-stop feature. Alternatively, the power system can be connected to a network to watch over and provide fault protection mechanisms. A processor within the power system can execute the quick-stop feature by deactivating the power output. Deactivating the power output can follow a programmed shutdown, a sequenced shutdown or a complete shutdown. Downprogrammers ensure deactivating the power output in the shortest time.

### BACKGROUND OF THE INVENTION

Contemporary Direct Current power systems have a simple control button or switch to turn the output supply on or off (“on-off control”). These on-off controls are typically located on power system's front panel. In the case of power systems with multiple outputs, there may be more than one control apparatus to turn the outputs on or off.

The on-off controls turn-off and deactivate the power output of the output supplies within a reasonable amount of time. The deactivation routine typically includes a delay imposed by the manufacturer (“factory programmed delay”) to turn-off the power output in a controlled sequence. The factory programmed delay is a delay programmed into the power system by the manufacturer when deactivating the power output.

However, precision electronic equipment connected to the power systems are not always protected against power surges or disruptions from the power system.

In the event of an emergency, where power needs to be disconnected quickly from the external devices, a single key to disable the entire system is not readily available to an operator. In addition, the present on-off controls may not respond in the fastest possible manner. Often users will turn-off the entire system using the power switch. This may result in an uncontrolled power down transition, resulting in damage to the external devices.

To overcome the problem described above, design engineers incorporate additional circuitry to monitor the various outputs of the power system. In addition to this, custom fault-protection mechanisms are also designed into external devices. This can include a shut down sequence for the various outputs of the power system. The external circuitry must be specially designed to interface to each power system. Another workaround is a hardware and software solution. With this option, external watchdog circuitry can task the power system to shutdown its power output.

Unfortunately, the solutions described above require additional design time and a thorough understanding of the interface of the power system. The complexity in setting up a system with external workarounds dissuades quick experimental work.

Accordingly, a need exists to expeditiously cut off the power output to external devices without damaging the power system or the external devices. This can comprise shutting down the power output of a power system either in an emergency or in a controlled environment in the shortest amount of time.

### BRIEF DESCRIPTION OF THE DRAWINGS

FIG. 1 is an operation diagram describing a quick-stop feature within a power system;

FIG. 2 is a power system illustrating an Emergency-Stop button on the front panel of the power system;

FIG. 3 is a flow chart describing the quick-stop feature; and

FIGS. 4A-B are schematic diagrams describing examples of downprogrammers in the power system.

### DETAILED DESCRIPTION

Described herewith is a quick-stop feature to deactivate an output supply of a power system with factory programmed delays associated with the on-off control feature set to zero. The quick-stop feature can be embodied as a hardware interface option on the power system or in combination with a software routine. For example, the hardware interface can include a button or a switch on the front panel power system. The software routine performs a watchdog function and commands the power system to power down the output supply. This can be facilitated using external device feedback signals as an input.

The quick-stop feature can be used with power systems with multiple output supplies. The feature can power down the output supplies at the same time or in a programmed sequence.

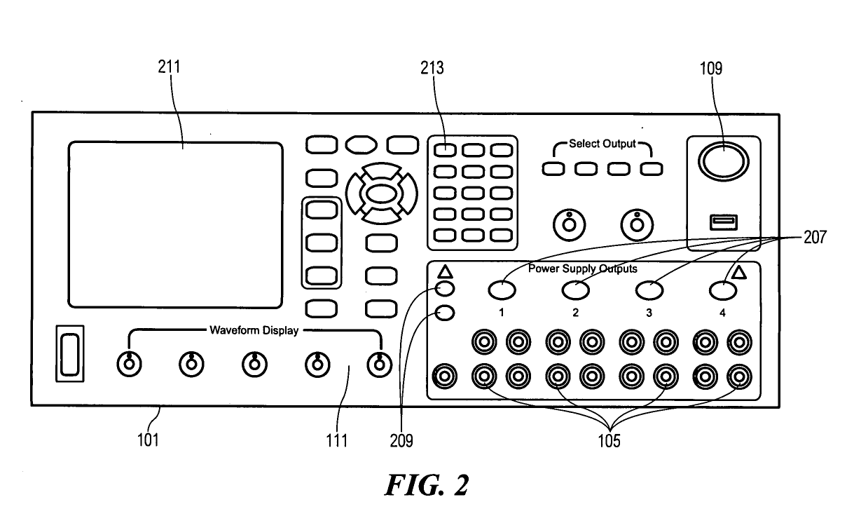

Deactivating the power output of the output supplies in a programmed sequence can be achieved through a graphical user interface (described below in FIG. 2), or done programmatically through a remote interface. The programmed sequence will not allow an operator to exceed the manufacturer factory programmed delay.

The quick-stop feature deactivates the power output in the fastest possible manner allowed by the power system. This minimizes the delays to shorter than those of the factory programmed delays associated with each power output of the power system.

An open circuit or a high impedance value at the terminals of the output supplies are hardware means of implementing the quick-stop feature. An open circuit or a high impedance value can be realized through relays or electronic circuits. To help reduce turn-off time and discharge capacitors connected to the power output, a downprogrammer circuit can be used.

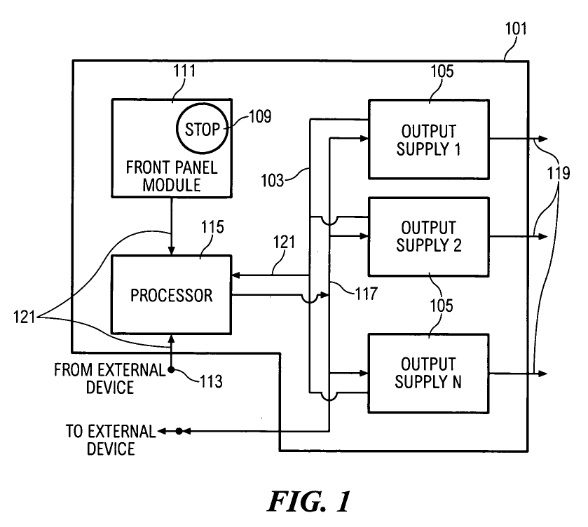

FIG. 1 is an operation diagram describing the quick-stop feature within a power system 101. The diagram illustrates a processor 115, and output supplies 1 to N 105. A front panel 111 of the power system 101 is also illustrated in FIG. 1. The interfaces 121 provide inputs to the processor 115 to activate the quick-stop feature.

A Stop button 109 is located on the front panel 111. The Stop button 109 sends a signal input to the processor 115 when the Stop button 109 is activated. Feedback signals 103 of the power output 105 are connected to the processor 115.

The output supplies 105 are connected to the input of external devices 119 to supply the requisite power. Another set of feedback signals 113 from external devices (not shown) is connected to the processor 115.

When the Stop button 109 is activated or the signal 113 sent from an external device, the processor 115 sends a Stop signal 117 to enable the hardware means within the power system to deactivate the output supplies 105.

The processor 115 can act as a watchdog to analyze the power consumption of the external devices. In this setup, the feedback signals 113 from external devices can consist of data comprising voltage and current consumption, and operating temperature of the external devices. The feedback signals 113 can also comprise a signal requesting the power system 101 to deactivate the power output of the supplies 105. The feedback signals 113 can be networked through an electrical network to link the external devices and the power system 101. Examples of an electrical network are the General Purpose Instrument Bus, Ethernet (LAN), USB, LXI and PXI. In addition, the LAN connection can support an internet browser interface to provide remote front panel control. The Stop signal 117 can also be sent to the external devices to communicate the event occurrence to the external devices.

FIG. 2 is a drawing of the power system 101 with the quick-stop feature incorporated into its design. The power system 101 comprises four output supplies 105. The output supplies have individual on-off control toggle buttons 207.

The power system 101 also has a graphical user interface 211 and a numerical keypad interface 213 to program a deactivation sequence.

The Stop button 109 is located on the front panel 111 of the power system 101. The button 109 is prominent and can be marked ‘Emergency-Stop”. The button 109 can be colored red to highlight its feature.

Associated with the power system 101 is an “overall control” 209 with buttons to turn the power output of all the output supplies 105 on or off. The overall control 209 activates or deactivates the power output with a single control mechanism. The overall control 209 is located within the proximity of the output supply terminals.

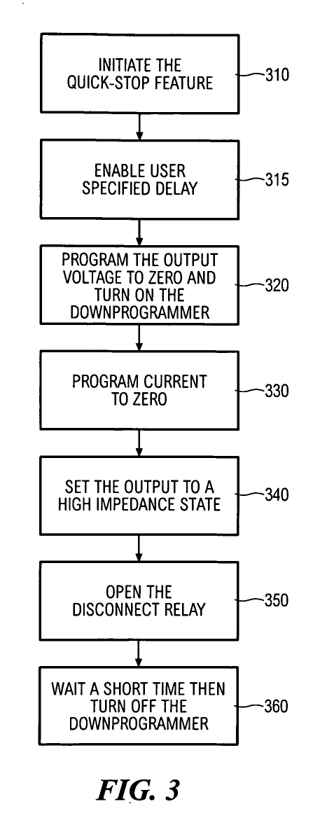

The overall control 209 and the on-off toggle buttons 207 utilize the factory programmed delay to power down the output supplies 105 in a reasonable amount of time. For example, the factory programmed delay can range from 40 ms to 80 ms. This specification is dependent on the power system 101 manufacturer's specifications. A supplemental delay time can be specified in certain power system models via the graphical interface 211 of the power system 101. The factory programmed delay and supplemental delay are collectively termed “pre-programmed power output deactivation delay.” When there is no supplemental delay used, the factory programmed delay can also be termed the pre-programmed power output deactivation delay. Once the pre-programmed power output deactivation delay has elapsed, the output follows a shut down procedure (described in FIG. 3).

As mentioned above, when the quick-stop feature is activated, the feature routine shortcuts the delays inside the power system 101. The quick-stop feature routine parallels a protect-and-shut-off (“Protect Shut Off”) deactivation sequence used in the power system. These protection features are for example, Over Voltage Protection (OVP), Over Current Protection (OCP), and Over Temperature Protection (OTP). The Protect Shut Off routine shuts down the power output without the pre-programmed power output deactivation delay in order to achieve the shortest deactivation time. The Protect Shut Off routine is not readily available to the operator from the front panel 111 of the power system 101. The quick-stop feature is a means to enable the operator to activate Protect Shut Off routine without the pre-programmed power output deactivation delay.

The quick-stop feature is optimized to speed up the removal of power from the output terminals 105 in the shortest possible time. The power output is deactivated with the pre-programmed power output deactivation delay (designed to be incorporated into the overall control 209 feature) set to a minimum or bypassed altogether. For example, the power output can be shut off in as little as 20 ms or less with the quick-stop feature. In other power systems, the power output can be shut down in 30 ms or less. The shut down time is dependent on the power system hardware and is at least as fast as or faster than the overall control 209 sequence with the overall control 209 pre-programmed power output deactivation delay set to zero. The shut down time can approach zero seconds in advanced power systems. This differentiates the Emergency-Stop button 109 of the quick-stop feature from the overall on-off button 209.

To allow the operator limited design freedom in shutting down the power output in an emergency scenario, the operator can specify delays (“user specified delays”) to be used with the quick-stop feature. The user specified delays of the quick-stop feature are restricted to be less than the pre-programmed power output deactivation delay used in the overall control 209. This benefits the operator by allowing the operator to shut down critical external devices ahead of other external devices during an emergency shutdown.

FIG. 3 is a flow chart describing the steps taken by the quick-stop feature to deactivate the power output of a power system 101.

Block 310 includes the steps of initiating the quick-stop feature. The quick-stop feature can be initiated through various interfaces. These interfaces can comprise a signal sent from the Stop button 109 or the signal 113 from the external devices requesting the power output to be deactivated. In addition to the interfaces above, the quick-stop command can be initiated by monitoring feedback signals 103 of the output supplies 105 or monitoring feedback signals 113 from the external devices.

Block 315 describes enabling the user specified delay. If the operator has programmed the user specified delay for a specific number of the output supplies 105, the processor 115 will delay the execution of Blocks 320 to Blocks 360 for the power output of the particular output supplies by the user specified delay period.

Block 320 includes the steps of having the power system 101 set the output voltage to a minimum amount, for example zero volts. This activates the downprogrammers to set the voltage to the minimum amount.

Block 330 includes the steps of having the power system 101 set the output current to a minimum amount, for example zero amperes. Block 340 identifies setting the terminals of output supplies 105 to a high impedance state. The actual impedance levels and implementation details of creating high impedance at the output terminals of the output supplies 105 are dependent on the power system 101 design. Most designs remove any active sourcing and sinking capability from the power system.

Block 350 includes the steps of opening the disconnect relay. The disconnect relay is a mechanical relay placed in series with output terminals of the power output. The disconnect relays are used to create an “open circuit” and mechanically break the electrical connection between the output terminals and the external device. The disconnect relay may not be present on all power systems.

Block 360 includes the steps of waiting a short time before turning off the downprogrammer. The time required varies with the hardware design of the power system 101. The power system 101 is typically designed to wait until all electric charge dissipates from output capacitors that are connected to the output supplies 105. The time can range from zero to approximately 100 ms.

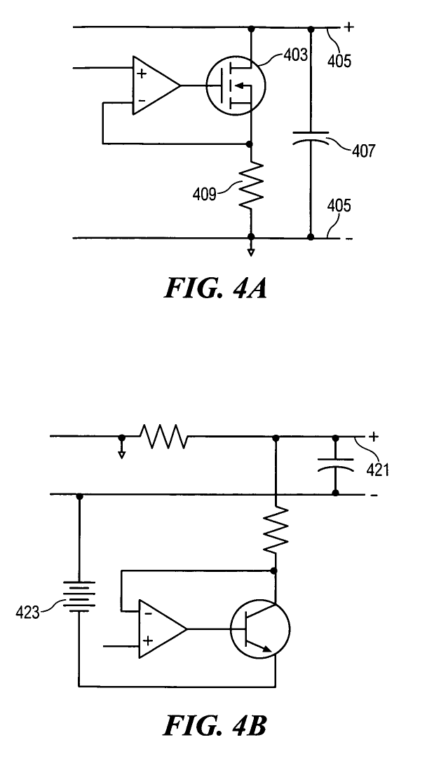

FIGS. 4A and 4B are schematic drawings of downprogrammers used within the power system 101. The downprogrammer can be thought of as an internal load across the power system's output terminals that helps lower the power output of the output supplies 105 in a short time.

In FIG. 4A, a field effect transistor (FET) 403 is placed across a pair of output terminals 405. Whenever the output voltage is higher than the programmed value, the FET 403 activates and discharges an output capacitor 407. The FET 403 can sink currents ranging from 10 percent to 20 percent of the supply's 105 output current rating. The maximum load at low voltages is limited to the on-resistance of the FET 403 and a series monitoring resistor 409, resulting in a slight degradation of the downprogramming current near zero volts.

In FIG. 4B, the downprogrammer lies between the power system's positive terminal 421 and a negative source 423. This configuration lowers the voltage at the power output down completely with no degradation near zero volts.

The primary function of the downprogrammer is to discharge the power system's output capacitor 407 but in some cases, this feature may be used as a load to the external device. The output supplies 105 might be used to both charge and discharge external devices such as capacitors or batteries.

Downprogramming circuits in power systems 101 rapidly decrease the output voltage, reducing discharge times by hundreds of milliseconds. The supplies 105 can vary the amount of current the supplies 105 can sink. Some power systems can sink currents equal to their full output current rating. As the sink current is programmable, the output supply can be used as both a programmable source and load.

While the embodiments described above constitute exemplary embodiments of the invention, it should be recognized that the invention can be varied in numerous ways without departing from the scope thereof. It should be understood that the invention is only defined by the following claims.

1. A power system comprising:
an interface for receiving a signal input; and
a processor for deactivating a power output in response to the interface receiving the signal input, the deactivating occurring in an interval of time less than a delay time of a pre-programmed power output deactivation delay.

2. The power system of claim 1, wherein the signal input comes from a signal fed-back from an external device.

3. The power system in claim 2, wherein the signal fed-back from the external device comprises voltage and current consumption or operating temperature of the external devices.

4. The power system of claim 1, wherein the signal input comes from a button or a switch on the power system.

5. The power system of claim 4, wherein the button or the switch is on a front panel of the power system.

6. The power system of claim 1, wherein the signal input comes from a signal fed-back from the power output.

7. The power system in claim 6, wherein the signal fed-back from the power output comprises voltage and current consumption or operating temperature of the power output.

8. The power system in claim 1, wherein the power output is operable to supply a programmable voltage output or a programmable current output.

9. The power system in claim 1, wherein the interval of time is set by a user.

10. The power system in claim 1, wherein the processor activates a downprogrammer at output terminals of the power output to begin deactivating the power output.

11. A method for deactivating a power output of a power system comprising the steps of:
receiving a signal input; and
deactivating the power output in response to the signal input in an interval of time less than a delay time of a pre-programmed power output deactivation delay.

12. The method of claim 11, further comprising the step of supplying a feedback signal from an external device to the signal input of the power system.

13. The method of claim 11, further comprising the step of supplying the signal input to the power system in response to activating a button or a switch on the power system.

14. The method of claim 13, wherein the button or the switch is on a front panel of the power system.

15. The method of claim 11, further comprising the step of supplying a feedback signal from the power output to the signal input of the power system.

16. The method of claim 11, further comprising the step of setting the power output to a high impedance state.

17. The method of claim 16, further comprising the step of opening a disconnect relay of the power output.

18. The method of claim 17, further comprising the step of removing the power output from the high impedance state.

19. The method of claim 11, further comprising the step of setting, by a user, the interval of time.

20. The method of claim 11, wherein the step of deactivating the power output further comprises the step of decreasing an output current of the power output.
